(19) United States
(12) Patent Application Publication
(10) Pub. No.: US 2015/0085055 A1
(43) Pub. Date: Mar. 26, 2015

(54) STAMPING PLATE HOLDER

(71) Applicant: CASIO COMPUTER CO., LTD., Tokyo (JP)

(72) Inventor: Takayuki KOGANE, Tokyo (JP)

(73) Assignee: CASIO COMPUTER CO., LTD., Tokyo (JP)

(21) Appl. No.: 14/492,799

(22) Filed: Sep. 22, 2014

(30) Foreign Application Priority Data
Sep. 24, 2013 (JP) 2013-196487

(51) Int. Cl. B41J 13/10

(52) U.S. Cl. CPC B41J 13/10
USPC 347/220

(57) ABSTRACT

A stamping plate holder comprises a thick cardboard configured to receive a stamping plate on a surface of the thick cardboard, the stamping plate that comprises a surface configured for plate-making processing to form a stamping face; and a paper strip, to be printed on with information relating to the stamping plate, that is arranged in an area outside of an area that receives stamping plate on the same surface as stamping plate of thick cardboard.

### CROSS-REFERENCE TO RELATED APPLICATION

This application claims the benefit of Japanese Patent Application No. 2013-196487, filed on Sep. 24, 2013, the entire disclosure of which is incorporated by reference herein.

### FIELD

The present disclosure relates to a stamping plate holder used during the production of stamping plates.

### BACKGROUND

A press seal that impregnates its stamping material with ink, the stamping material being a sponge rubber, to affix a seal is well-known. Unexamined Japanese Patent Application Kokai Publication No. H 10-100464 discloses a system that produces stamping plates of press seals such as the forgoing type. This system forms a stamping face comprising a melted and solidified part being non-permeable to ink, and a non-melted part being permeable to ink by pressure-contacting a surface of a porous sheet with a thermal head that includes a plurality of dot-like heating elements and selectively applying heat to the stamping material with the thermal head while conveying the thermal head.

However, the managing of multiple stamping plates produced by a production system such as indicated in Unexamined Japanese Patent Application Kokai Publication No. H10-100464 is cumbersome. For example, in order to manage multiple stamping plates, it is necessary for the user to perform tasks including the writing of information for identification purposes (for example, creation date, design pattern, and/or the like) onto each stamping plate, the registering of information pertaining to stamping plates into an information terminal, and the managing of this information.

In light of these circumstances, it is desirable to have a way to easily manage stamping plates.

### SUMMARY

The present disclosure has been made in order to solve the above-described circumstances, and it is an objective of the present disclosure to provide a stamping plate holder that can facilitate management of stamping plates.

In order to solve the above-explained issue, the stamping plate holder in the present disclosure includes a board configured to receive a stamping plate on a surface of the board, the stamping plate that comprises a surface configured for plate-making processing to form a stamping face; and a print medium arranged in an area on the surface of the board, the area being outside of an area that receives the stamping plate.

### BRIEF DESCRIPTION OF THE DRAWINGS

A more complete understanding of this application can be obtained when the following detailed description is considered in conjunction with the following drawings, in which:

FIG. 1 is a block diagram showing a printer structure of an embodiment;

FIG. 2 is a perspective view of the printer of the embodiment;

FIG. 3A is a plan view showing an internal structure of the printer of the embodiment;

FIG. 3B is cross-sectional view of the printer of the embodiment as shown in of FIG. 3A;

FIG. 4A is a plan view of a stamping plate holder of the embodiment;

FIG. 4B is a cross-sectional view of a stamping plate holder taken along line A-A′ shown in FIG. 4A;

FIG. 4C is a rear-view diagram of a stamping plate holder;

FIG. 5 is an enlarged view of area “b” shown in FIG. 4B with a dashed line;

FIG. 6 is a diagram schematically showing a press seal that employs a stamping plate;

FIG. 7A is a diagram showing a result of seal pressing;

FIG. 7B is a diagram showing a stamping plate before plate-making;

FIG. 7C is a diagram showing a stamping plate after plate-making;

FIG. 8 is a diagram showing an example on a strip of paper; and

FIG. 9 is a flowchart of plate-making processing.

### DETAILED DESCRIPTION

A stamping plate holder according to an embodiment for carrying out the present disclosure is explained in detail hereinafter with reference to the drawings.

Prior to explaining in detail about a stamping plate holder according to an embodiment, a thermal printer 1 for plate-making used to create a stamping plate (hereinafter referred to as “printer 1”) is explained.

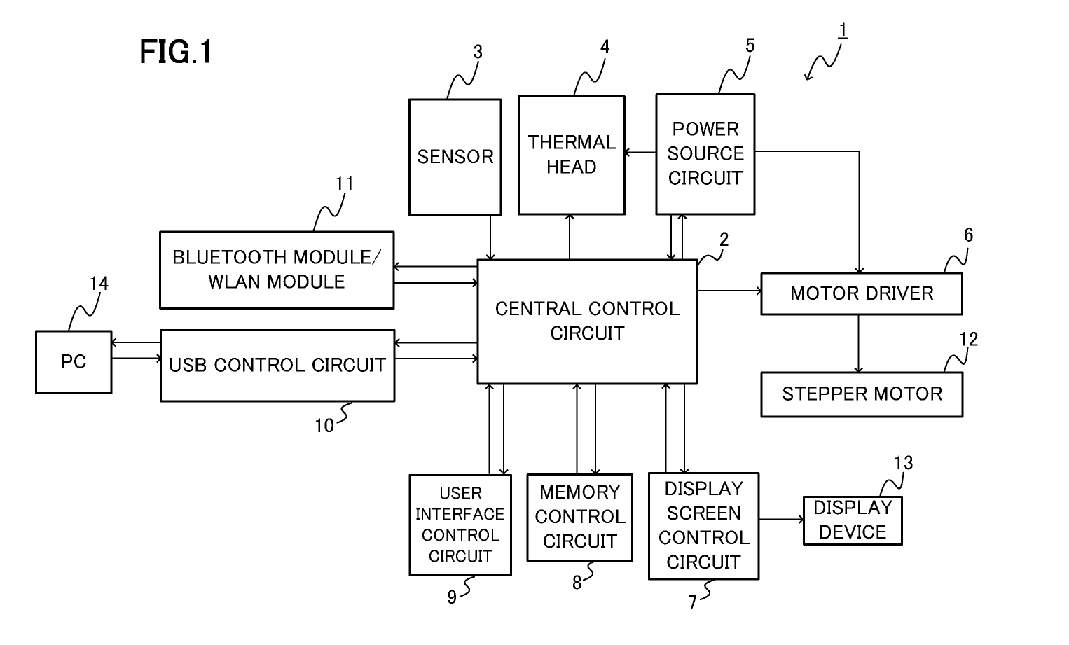

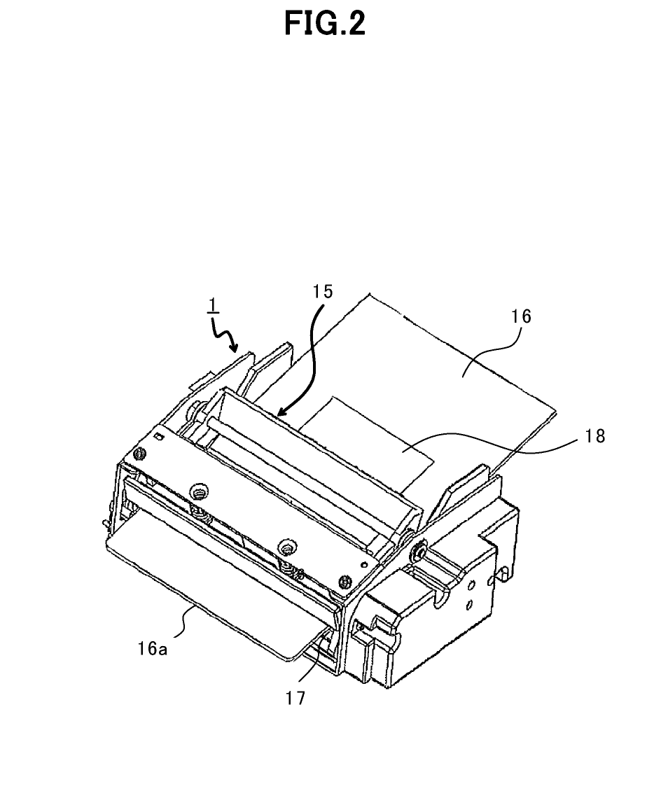

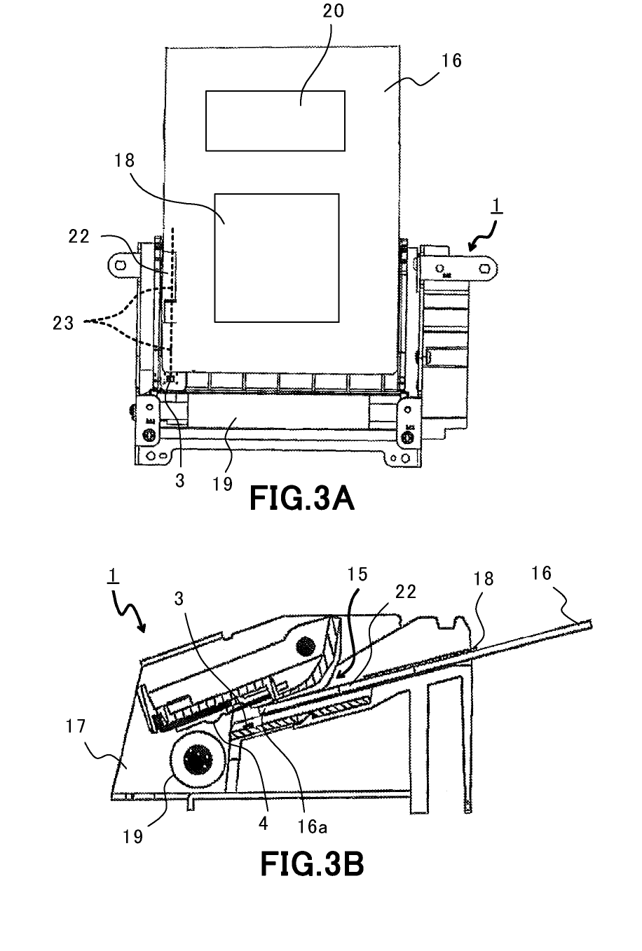

FIG. 1 is a block diagram showing a structure of printer 1. FIG. 2 is a perspective view showing the external appearance of printer 1 with a stamping plate holder 16 attached. FIG. 3A is a plan view schematically showing an interior of printer 1 whereas FIG. 3B is a cross-sectional view of printer 1 shown in FIG. 3.

As shown in FIG. 1, printer 1 includes a central control circuit 2, a sensor 3, a thermal head 4, a power source circuit 5, a motor driver 6, a display screen control circuit 7, a memory control circuit 8, a user interface control circuit 9, a USB (Universal Serial Bus) control circuit 10, a Bluetooth (registered trademark) module and wireless LAN (Local Area Network) module 11, a stepper motor 12, and a display device 13.

When it is essential for printer 1 to be connected (wired connection or wireless connection) to a PC (Personal Computer), the user executes operation of printer 1 via PC 14 or a GUI (Graphical User Interface) of a mobile terminal not shown, and/or the like. Please note that display screen control circuit 7 and display device 13 can be omitted. Display device 13, display screen control circuit 7, user interface (UI) control circuit 9, USB control circuit 10, Bluetooth (registered trademark) module and wireless LAN (Local Area Network) module 11, and/or the like can be omitted as necessary.

Central control circuit 2 comprises a CPU (Central Processing Unit), and/or the like, and controls an entire system. Although FIG. 1 shows an example of a structure in which most of the circuits are only connected to the central control circuit 2, the structure is not limited to this, and may be a structure in which the circuits are mutually connected via a bus to perform data communication.

Sensor 3, for example, comprises a reflection-type optical sensor. Sensor 3 detects a notch 22 disposed on stamping plate holder 16 described later.

Thermal head 4 includes a driver IC (Integrated Circuit). Driver IC receives data and a printing signal output from central control circuit 2 and in accordance with the data, performs heating and non-heating control of energizing dots (heating elements) in the driver IC (Integrated Circuit) located inside thermal head 4. This enables thermal head 4 to apply printing to a stamping plate made up of a porous ethylene-vinyl acetate (EVA) copolymer, and/or the like. Note that printing on a stamping plate is also called plate-making for stamping face formation.

Power source circuit 5 which includes a power source IC (Integrated Circuit), and/or the like supplies necessary power to each circuit.

Motor driver 6 receives a drive signal output from central control circuit 2 and supplies drive power to stepper motor 12. Note that motor driver 6 may receive only an excitation signal from central control circuit 2, and stepper motor 12 may obtain actual drive power from power source circuit 5.

In the present embodiment, central control circuit 2 can determine how many times stepper motor 12 is rotated by counting the pulse number of signals output to motor driver 6. How often stamping plate holder 16 is conveyed is determined based on this number of rotations. In the present embodiment, note that stepper motor 12, as a one-to-two phase excitation motor is configured by gearing for 1 line (0.125 mm) translation per 16 steps. In other words, in the present embodiment, a conveyance of 0.0078 mm is performed in each step,

Display screen control circuit 7 performs data transfers to display device 13, controls the turning on and turning off of a light, and/or the like. Display device 13 includes, for example, a display apparatus such as an LCD (Liquid Crystal Display), and/or the like.

Memory control circuit 8 includes and controls devices such as ROM (Read Only Memory), RAM (Random Access Memory), and/or the like.

User interface control circuit 9 controls the display of a menu screen, and/or the like based on information input from an input device including a keyboard, mouse, remote control, button, touch panel, and/or the like.

USB control circuit 10 is connected to PC (Personal Computer) 14.

Bluetooth (registered trademark) module and wireless LAN module 11 is a module that provides wireless communication between printer 1 and a portable terminal such as a smartphone. The user, for example, is able to transmit various types of data, described below, to printer 1 via a mobile terminal by short-distance wireless communication of a Bluetooth (registered trademark) module, and/or the like.

As shown in FIG. 2, printer 1 includes a print medium insertion opening 15 into which stamping plate holder 16 is inserted, and ejection opening 17 which ejects stamping plate holder 16. FIG. 2 shows a state in which stamping plate holder 16 is inserted in print medium insertion opening 15 and tip 16a of stamping plate holder 16 is protruding to the outside of ejection opening 17. The details are explained later but stamping plate 18 is retained in stamping plate holder 16. Also, FIGS. 3A and 3B show a state just after stamping plate 16 is inserted in print medium insertion opening 15 of printer 1. In this state, tip 16a of stamping plate holder 16 is to be inserted as far as the vicinity of the arranged position of sensor 3. Sensor 3 senses along dashed line 23 shown in FIG. 3A, and detects a notch 22 formed on the side of stamping plate holder 16. Also, as shown in FIG. 3B, printer 1 includes a thermal head 4 and a platen roller 19 on the conveyance path of stamping plate holder 16.

Next, stamping plate holder 16 is explained.

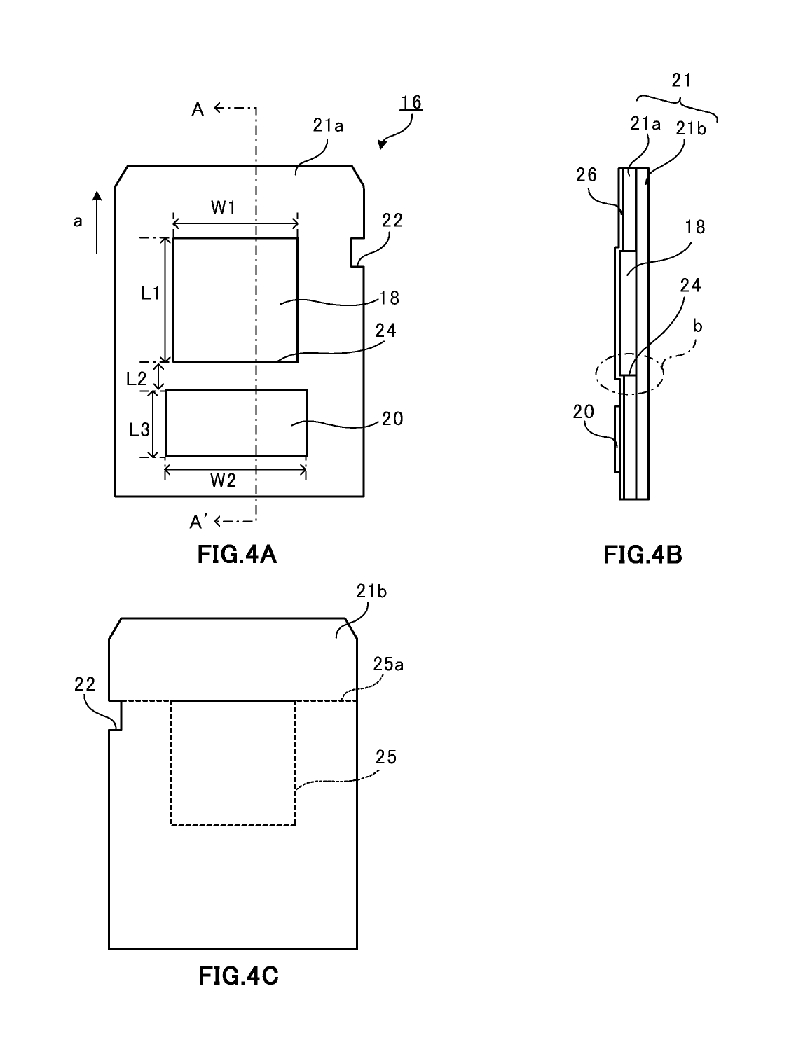

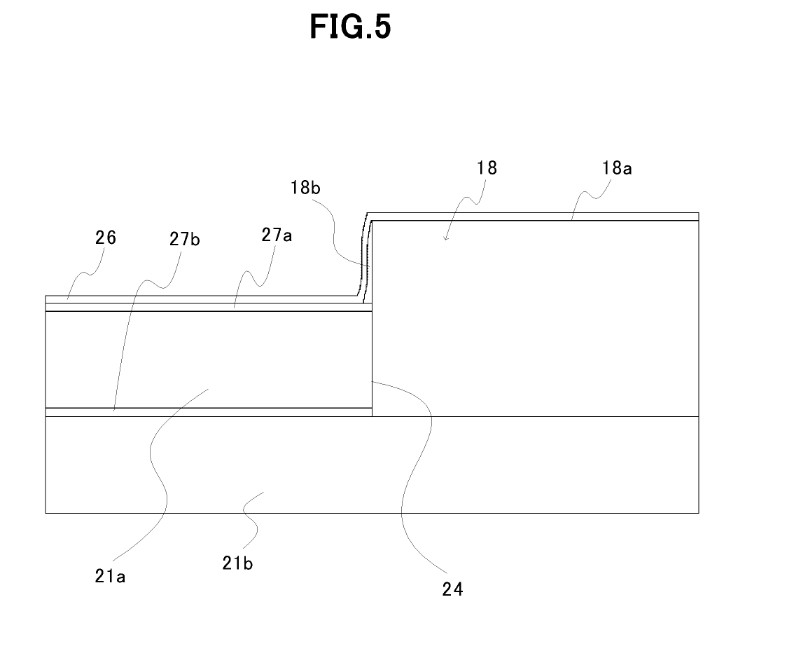

Stamping plate holder 16 is shown in FIGS. 4A-4C and FIG. 5. FIG. 4A is a plan view of stamping plate holder 16 retaining stamping plate 18. FIG. 4B is a cross-sectional view of stamping plate holder 16 taken along line A-A′ shown in FIG. 4A. FIG. 4C is a rear-view diagram of stamping plate holder 16. Note that the arrow “a” shown in FIG. 4A shows the conveyance direction of stamping plate holder 16 in printer 1. FIG. 5 is an enlarged view of area “b” that is encircled with a dashed line shown in FIG. 4B.

As shown in FIGS. 4A and 4B and FIG. 5, stamping plate holder 16 includes a paper strip 20, a thick cardboard 21, notch 22, a recess 24 for removably retaining a stamping plate 18, and a film 26.

Recess 24 is provided in the center of stamping plate holder 16, and stamping plate 18 is fitted in and retained. Stamping plate 18 comprises a porous sponge body that can be impregnated with ink. As the material of this sponge body, an ethylene-vinyl acetate (EVA) copolymer, for example, is used.

As shown in FIG. 4B and FIG. 5, the recess is configured to have a depth such that the top portion (a stamping face or a stamping face formation target surface) of loaded stamping plate 18 slightly protrudes beyond the top portion of thick cardboard 21. To be more specific, stamping plate holder 16 comprises a top thick cardboard 21a and a bottom thick cardboard 21b laminated together. An opening is formed on top thick cardboard 21 where stamping plate 18 is fitted. The thickness of stamping plate 18 is formed to be, for example, 1.5 mm, and the thickness of top thick cardboard 21a is formed to be, for example, 0.79 mm Thus, when stamping plate 18 is fitted in to recess 24, the top surface of stamping plate 18 slightly protrudes beyond the top surface of top thick cardboard 21a. Thermal head 4 can perform plate-making while slightly crushing stamping plate 18. Note that all four sides of stamping plate 18 are cut by a thermal cutting machine. Thus, the ink impregnating the inside of stamping plate 18 does not ooze from the four sides of stamping plate 18.

As shown in FIGS. 4A and 4B, recess 24 that accommodates stamping plate 18 and paper strip 20 are arranged on the same surface as stamping plate holder 16. Of the two main surfaces of the stamping plate holder 16, the surfaces on which paper strip 20 and stamping plate 18 are arranged is the printing surface on which printing by thermal head 4 of printer 1 is applied.

Paper strip 20 is a medium on which printing is applied. Heat-sensitive paper is used for paper strip 20. Also, printing is applied onto paper strip 20 by thermal head 4. Information relating to the stamping face (for example, the date the stamping face was created, information relating to the save destination of the seal impression data, color information when the stamping face comprises a plurality of colors, and/or the like.) is printed on paper strip 20. The planar shape of paper strip 20 can be rectangular as shown in FIG. 4A, or can be suitably changed to a square with four equal sides, a round shape, elliptical shape, and/or the like.

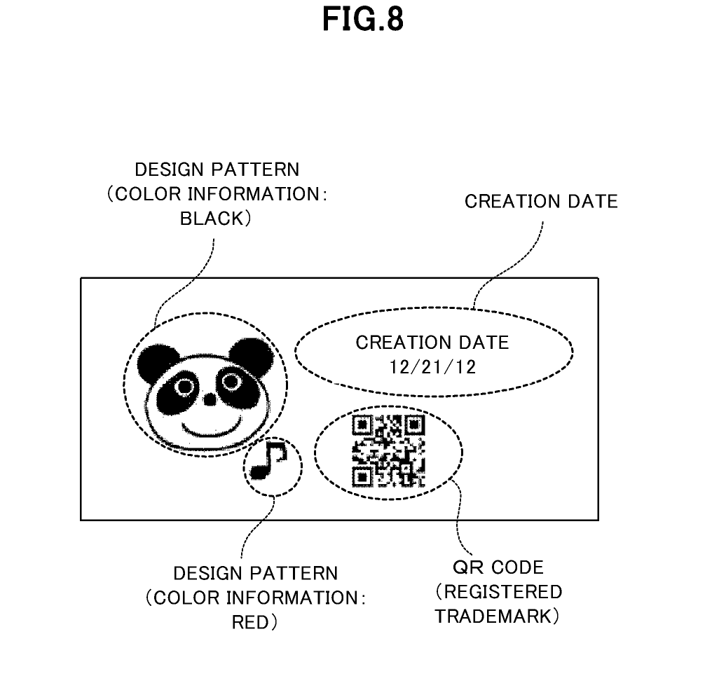

FIG. 8 shows an example of information recorded on paper strip 20. In this example, information relating to the stamping plate, such as the date the stamping plate was created, is printed onto paper strip 20. This makes it easy to manage stamping plate 18. Also, the information displayed on paper strip 20 can also include information indicating the save destination of data essential for plate-making (for example, an address). Information indicating the save destination is inscribed using, for example, characters, numbers, a two-dimensional code such as a QR code (registered trademark), and/or the like. The recording of information indicating the save destination enables quick retrieval of data based on such information when re-creating the same press seal, when a different person creates a similar press seal, or when updating seal impression data to create a new press seal.

Also, if the design pattern of the stamping face is to contain multiple colors, displaying the color information on paper strip 20 indicating which area of the design pattern has which color, provides great convenience when impregnating stamping plate 18 with ink. In the example shown in FIG. 8, information is recorded indicating that the design pattern of the panda is black, and that the design pattern of the musical note is red. The color information can be included using written letters or symbols, for example, the word “black” can be affixed to the design pattern of the panda, and the word “red” can be affixed to the design pattern of the musical note. Also, if the paper strip 20, which is heat-sensitive paper, changes to various colors by heat processing, the design pattern of the panda can be printed in black, and the design pattern of the musical note can be printed in red, and also the printed design patterns can be displayed on paper strip 20 to make the colors easily recognizable.

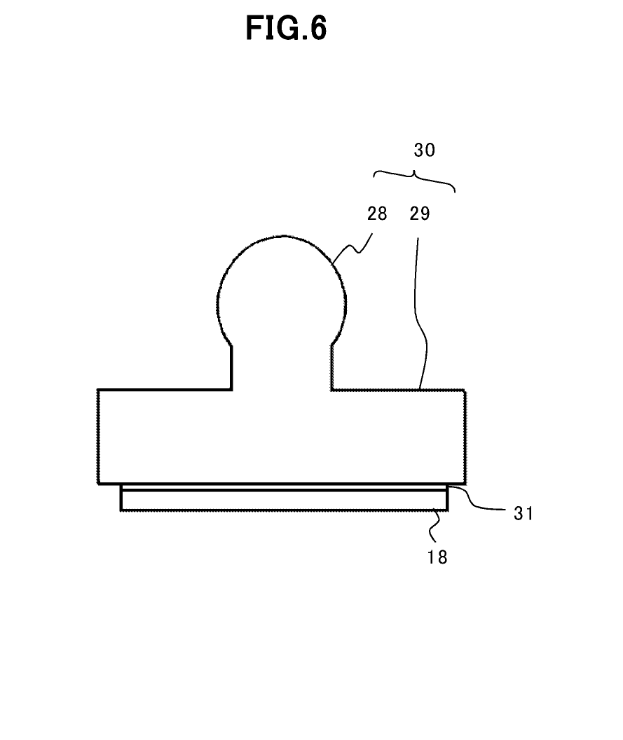

Paper strip 20 is adhered to stamping plate holder 16 by glue, an adhesive agent, and/or the like. The choice to use glue, adhesive agent, and/or the like, can be made based upon the application of paper strip 20. For example, by folding thick cardboard 21 into a mountain-shape, stamping plate holder 16 can be utilized as a platform for retaining the press seal shown in FIG. 6. In such a situation, as the stamping plate holder 16 is used with paper strip 20 adhered thereto, the stick-and-peel function, such as with an adhesive agent, is not necessarily essential.

However, if the user sticks paper strip 20 to stamp wooden base 30 of the stamp shown in FIG. 6, then it is necessary to have an adhesion means for peeling paper strip 20 from stamping plate holder 16, and sticking paper strip 20 to stamp wooden base 30. The same applies to objects other than stamp wooden base 30. An adhesive agent that has a stick-and-peel function, a double-sided tape including a base material with glue or an adhesive agent on both sides, and/or the like can be used as a means for adhesion.

Paper strip 20 can be positioned anywhere on a surface of stamping plate holder 16, so long as the surface is the side that allows paper strip 20 to come in contact with thermal head 4 while plate-making processing is performed. Paper strip 20 can be positioned so that printing is applied after the plate-making of stamping plate 18 (In FIG. 4A, referring to directly below stamping plate 18). Paper strip 20 can also be positioned adjacent to stamping plate 18 (In FIG. 4A, the position can be either to the right or left of stamping plate 18, or on both sides of stamping plate 18) so that paper strip 20 is printed at the same time as stamping plate 18. Also, paper strip 20 can be set at any distance from stamping plate 18.

In the present embodiment, as explained below in plate-making processing, there is a process in which the thermal head 4 is preheated before printing is applied to stamping plate 18. Also, from the standpoint of utilizing the preheating prior to applying printing to stamping plate 18 and from the standpoint of reducing the time duration for plate-making, it is preferable that paper strip 20 can be printed in the thermal head-pre-heating stage. Concretely, when stamping plate holder 16 is inserted in print medium insertion opening 15 of printer 1, paper strip 20 is positioned so that paper strip 20 is heat-processed by thermal head 4 before stamping plate 18 (in other words, directly above stamping plate 18 in FIG. 4A). Moreover, the number of paper strip 20 is not limited to one, so multiple sheets can be used.

Thick cardboard 21 can be formed from board-type paper. Concretely, thick cardboard 21 comprises top thick cardboard 21a and bottom thick cardboard 21b that are bonded together by a double-sided adhesive sheet 27b as shown in FIG. 5. Top thick cardboard 21a and bottom thick cardboard 21b are made of thick paper such as coated board. The center area of top thick cardboard 21a is provided with an opening that corresponds with the shape of stamping plate 18. Conversely, bottom thick cardboard 21b is not provided with an opening in the center area. The opening of top thick cardboard 21a and the bottom thick cardboard 21b provided below the opening form recess 24. Stamping plate 18 is positioned and retained in this recess 24. In other words, thick cardboard 21 is configured to receive stamping plate 18 on one side of thick cardboard 21.

Bottom thick cardboard 21b and top thick cardboard 21a are formed to have the same outer shape and the entire internal surface is formed to be a flat surface. Bottom thick cardboard 21b and top thick cardboard 21a are bonded together to form a single body, and bottom thick cardboard 21b contacts the bottom surface of stamping plate 18 thereby retaining stamping plate 18 from the bottom. As shown in FIG. 4C, this bottom thick cardboard 21b is provided with perforations 25 that run along one side of recess 24 shown in FIG. 4A. The upper part of perforations 25 extends from the right and left to both sides of bottom thick cardboard 21b forming perforations 25a.

Notch 22 is formed on one part of a side of stamping plate holder 16 (right side in FIG. 4A). Printer 1 uses sensor 3 to detect notch 22 along dashed line 23. The end of notch 22 and the end of stamping plate holder 18 are arranged at the same distance from a stamping plate holder edge 16a. Therefore, by detecting notch 22 mentioned in detail further below, the printing start position of stamping plate 18 can be determined.

Film 26 is made of heat-resistant thermally-conductive materials having surface smoothness, for example PET (Polyethylene Terephthalate), polyamide, or the like as a base material. With respect to heat-resistance, a film 26 having a higher melting point than the melting point of stamping plate 18 is used a film 26. In the present embodiment, the heat generated by thermal head 4 will not melt film 26 even if the surface of stamping plate 18 is melted by the heat. Also, the frictional force between film 26 and thermal head 4 is extremely low. Therefore, thermal head 4, due to the converting properties of film 26, does not become embedded in stamping plate 18 softened by melting. Also, thermal head 4 can easily continue plate-making along the surface of film 26, due to the low friction with film 26.

As shown in FIG. 5, film 26 and top thick cardboard 21a are adhered together by using double-sided adhesive sheet 27a. This means that surfaces of film 26 and stamping plate holder 16 are adhered together by double-sided adhesive sheet 27a.

Also, as shown in FIG. 4B, film 26 covers side surface 18b and front surface 18a of stamping plate 18 exposed from recess 24 to an area above the recess 24. However, film 26 is not adhered to side surface 18b and front surface 18a with glue. Upon completion of plate-making, bottom thick cardboard 21b is folded rearward along perforations 25a. Then, the portions surrounded by perforations 25 and 25a are pulled apart from top thick cardboard 21a. Afterward, stamping plate 18 can easily be extracted from stamping plate holder.

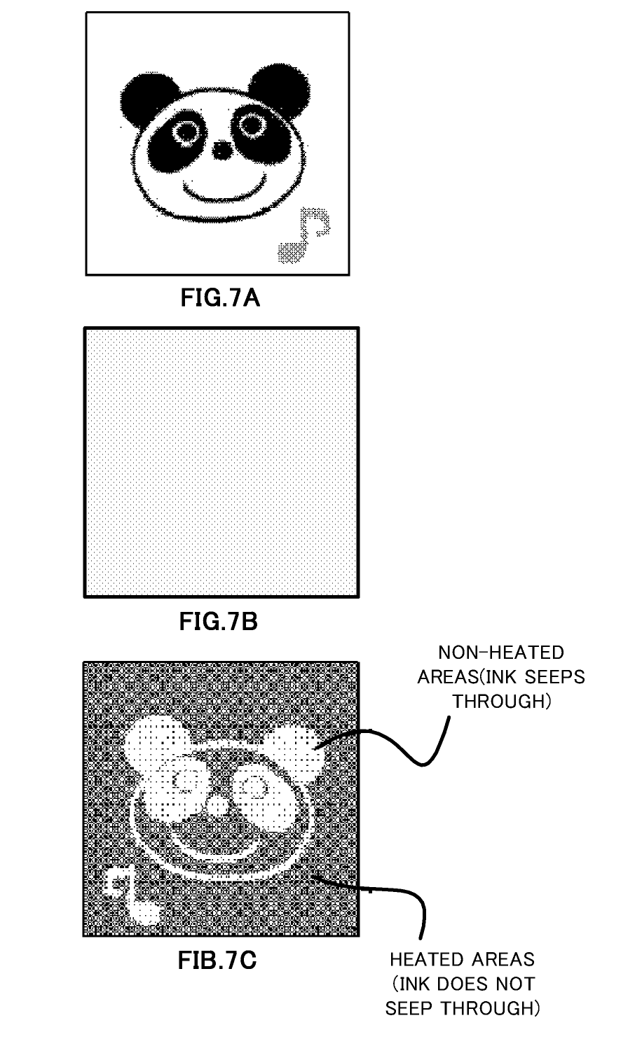

Next, the principle of plate-making by applying heat with a thermal head to the surface of porous EVA constituting plate 18 will be briefly explained while referencing FIGS. 7A-7C. FIG. 7A shows the seal-pressing result, FIG. 7B shows the stamping plate before plate-making, whereas FIG. 7C shows the stamping plate after plate-making.

Porous EVA (hereinafter simply referred to as EVA) which includes countless air bubbles makes it possible to impregnate the inside, which is like a sponge, with liquid such as ink. EVA also has thermoplasticity. For example, when heat ranging from 70-120 degrees is applied, the area on which heat is applied softens, and once the weakened area cools it hardens. Furthermore, the air bubbles in the hardened area get filled up making the area non-porous, thereby preventing liquid such as ink from passing through the area. Making good use of this characteristic of EVA, heat is applied by thermal head 4 to any area on the EVA surface for 1 to 5 milliseconds. Then the area is cooled to make the area non-porous. When this happens, ink is prevented from passing through the non-porous area.

Compared with the seal impression of the seal-pressing result shown in FIG. 7A, the white and black colors of seal impression printed on stamping plate 18 shown in FIG. 7C are inverted. In FIG. 7C, the area shown in black is the area on which heat was applied, and ink does not pass through this heated area. Conversely, since the non-heated areas remain porous, ink can pass through to achieve a desired seal pressing result. Also, the printing data used when printer 1 performs plate-making processing serves as the mirror data of the seal impression data created by the user (the design patterns of the pandas in FIGS. 7A and 7C). Note that a user creates the seal impression data with a predetermined application on a PC14 or a mobile terminal.

In the aforementioned heat processing of EVA surface, ink oozes out from the areas on which heat is not applied. As a result, the user must apply heat so that ink does not come out of areas other than the intended seal impression area.

However, an assembly error in a mass production step, for example, causes the center position of EVA to slightly deviate from the design value with respect to the center line of thermal head 4. In this situation, ink leaks from areas unintended by the user (for example, the edges of EVA). To concretely illustrate the point, suppose a user, for example, created seal impression data that is 30 mm×30 mm. Also suppose that the printing data, on which thermal processing is performed with thermal head 4, is also 30 mm×30 mm.

Now suppose that the position of EVA deviates by 1 mm in a scanning direction due to an assembly error. When this happens, not only does the center of the stamping face deviate by 1 mm, the 1 mm part on the edge that is unheated causes ink to leak from the edge.

In order to prevent this leakage of ink, data that indicates an area to be heated by thermal head 4 is provided around the periphery of the seal impression created by the user. The printing data with the heated area added is the printing data that is actually executed. The final printing data is the data with the heated area added around the periphery of a desired seal impression created by the user. This data is input into thermal head 4 and then plate-making processing is performed on stamping plate 18.

In order to address this kind of addition, the user is provided with, for example, stamping plate holder 16 that displays that the stamping plate holder 16 is to be used for stamping faces with a size of 30 mm×30 mm. At this time, the dimensions of the actual stamping plate are (30+L)×(30+L) mm, and L, for example, 1 mm-2 mm.

Upon completion of plate-making, stamping plate 18 extracted from stamping plate holder 16 is affixed to stamp wooden base 30 as shown in FIG. 6 and used as a seal. FIG. 6 shows that stamping plate 18, with stamping face oriented downwards, is attached, via double-sided adhesive sheet 31, to the bottom surface of stamp wooden base 30 consisting of a round handle 28 and a pressing part 29. Paper strip 20 shown in FIG. 8, for example, can be attached to the top surface or side surface or top surface of pressing part 29 of stamp wooden base 30. Paper strip 20 can also be attached to handle 28.

Also, by immersing the stamping face of stamping plate 18 in ink for a fixed duration, the ink impregnates the inside of the stamping face. After wiping away excess ink grime from the front surface of the stamping face, the user holds handle 28 by hand and presses pressing part 29 down on a to-be-sealed object. When this is done, the ink impregnated in stamping face is extruded out, thus forming an imprinted seal.

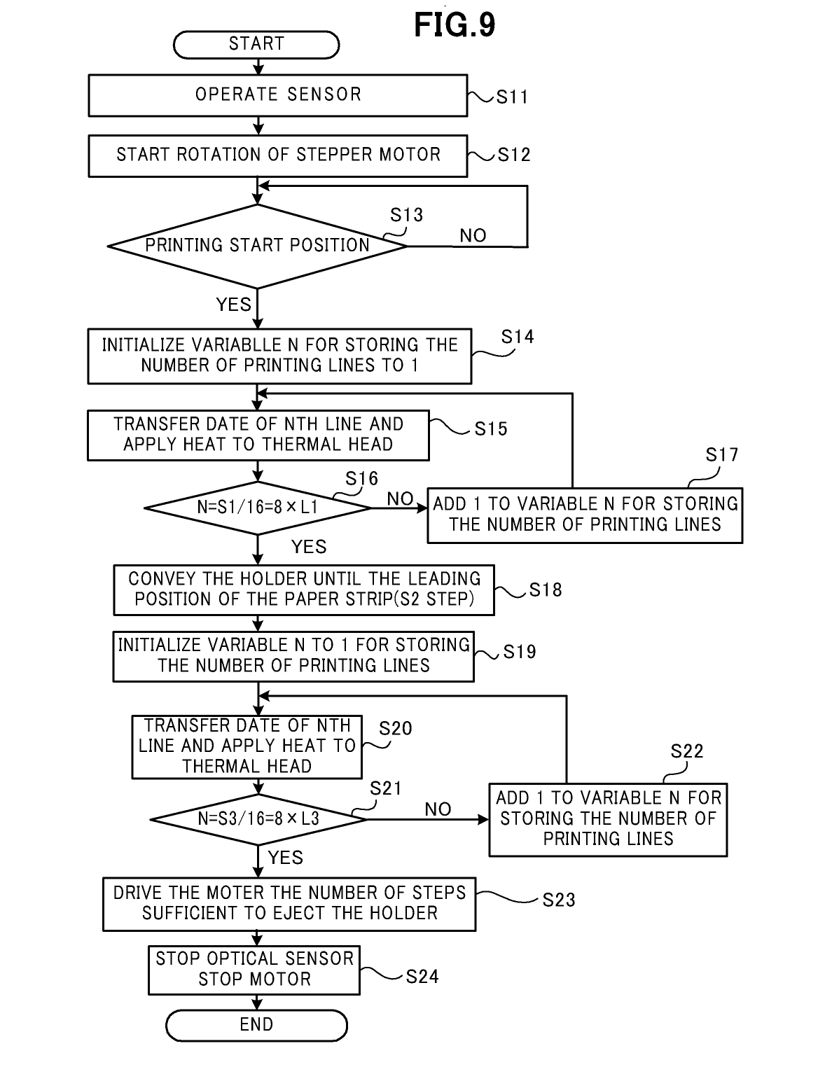

Next, plate-making processing carried out by central control circuit 2 (hereinafter referred to as controller) of printer 1 is explained with reference to the flowchart shown in FIG. 9. Note that for this plate-making processing, seal impression data and data relating to stamping plate 18 are sent to printer 1 from PC 14 or a mobile terminal. Also, plate-making processing is prompted to start upon receipt by printer 1 of the various types of sent data.

Concretely, a user creates seal impression data (for example, data indicating the design pattern of a panda shown in FIGS. 7A and 7C) with a predetermined application on PC 14 or a mobile terminal. In addition to seal impression data, a user inputs dimension data and paper strip data into PC 14 or a mobile terminal. Here, dimension data refers to data necessary for printing stamping plate 18 and paper strip 20 including the dimensions of stamping plate 18 (W1 and L1 shown in FIG. 4), dimensions of paper strip 20 (W2, L3 shown in FIG. 4A), the distance between paper strip 20 and stamping plate 18 (L2 shown in FIG. 4), and/or the like. Note that W1 and L1 are dimensions after the aforementioned heating area is added to the stamping face on display to the user.

Here, for the inputting of the dimension data, the user can input or select a serial number of stamping plate holder 16 from PC 14 or a mobile terminal. Alternatively, the dimensions of stamping plate 18, paper strip 20, and/or the like can be input or selected individually from PC 14 or a mobile terminal. Note that data such as the serial number of stamping plate holder 16, is preliminarily associated with data including dimensions of stamping plate 18, paper strip 20, the distance between stamping plate 18, paper strip 20, and/or the like.

Also, paper strip data is information that the user desires to display on the paper strip, for example, information such as the seal impression data, the creation date and the save destination of the data. This paper strip data is created by the user with a predetermined application.

Here, the seal impression data and the paper strip data created by the user, and the dimension data input or selected by the user, are transmitted to printer 1 via PC 14 or a mobile terminal. Also, the plate-making processing explained hereafter commences once printer 1 received the various types of data.

First, the controller of printer 1 causes sensor 3 to operate upon receipt of the various types of data (Step S11). Concretely, the controller receives the various types of data, then pre-heating processing of thermal head 4 is performed, and when the controller enters print standby state, the controller causes sensor 3 to operate. At this time, the controller illuminates a lamp (not shown in the diagrams) arranged on printer 1 to notify the user that printing 1 is printer-ready.

The user that has confirmed the lamp inserts stamping plate holder 16 in print medium insertion opening 15 of printer 1. Once sensor 3 detects a tip 16a of stamping plate holder 16, the controller commences with rotation of stepper motor 12 (Step S12). Concretely, the controller supplies a pulse signal that rotates stepper motor 12 that in turn drives the rotation of platen roller 19.

When an edge of notch 22 of stamping plate holder 16 is inserted as far as sensor 3, the light emitted from sensor 3 stops reflecting due to stamping plate holder 16. Thus, sensor 3 detects notch 22 and the controller determines that notch 22 of stamping plate holder 16 reached sensor 3.

Next, the controller starts measuring the number of steps in a pulse signal that is supplied to stepper motor 12.

Here, the size of the heating elements of thermal head 4 of the present embodiment is 0.125 mm per line meaning 8 lines are equal to 1 mm. Also, stepper motor 12 of the present embodiment as a 1-2 phase excitation motor has a gear ratio that is 16 steps per line (0.125 mm). As a result, for example, a 1 mm conveyance is performed in 128 steps. Therefore, if the conveyance distance is represented as D (mm), the number of steps S in relation to the conveyance distance D is expressed as S=128×D.

One edge of notch 22 and an edge corresponding with the printing start position of stamping plate 18 are arranged at the same distance from tip 16a of stamping plate holder 16. In printer 1, the distance separating sensor 3 and thermal heat 4 is predetermined Therefore, the number of steps that need to be conveyed for the printing start position of stamping plate 18 to reach thermal head 4 from the point in time sensor 3 detects notch 22, is also predetermined.

Therefore, when the edge of notch 22 is detected by sensor 3, the controller starts measuring the number of steps in a pulse signal supplied to stepper motor 12. In this way, the controller determines whether the predetermined number of steps were conveyed, and in turn determines whether stamping plate 18 of stamping plate holder 16 reached the printing start position (Step S13).

When the controller determines that stamping plate 18 did not reach the printing start position (Step S13: No), the controller rotates stepper motor 12 by a single step and conveys stamping plate holder 16 only for a single step rotation.

Next, when the controller determines that stamping plate 18 reaches the printing start position (Step S13: Yes), the controller initializes variable N for storing the number of printing lines by one (Step S14). Next, the controller transfers the seal impression data of Nth-line to thermal head 4, and applies heat to thermal head 4 (Step S15). As explained previously, the printing data that is actually executed is the data relating to the heating area that is added around the periphery of the seal impression created by the user.

Suppose that the length of the conveyance direction of stamping plate 18 is L1 (mm) (see FIG. 4A) and suppose that S1 is the number of steps when the printing of stamping plate 18 is complete. The printing of stamping plate 18 finishes when variable N for storing the number of printing lines reaches N=S1/16=8×L1.

Therefore, by determines whether N is this value, the controller determines that the printing of stamping plate 18 is finished (Step S16). If variable N for storing the number of printing lines does not satisfy 8×L1 (Step S16: No), the controller adds one to variable N for storing the number of printing lines (Step S17). Next, the controller transfers the data of Nth line again and applies heat to the thermal head (Step S15).

If variable N for storing the number of printing lines reaches 8×L1 (Step S16: Yes), then the controller drives stepper motor 12 and conveys stamping plate holder 16 as far as printing start position of paper strip 20 (Step S18). When this happens, suppose that the distance that separates stamping plate 18 and paper strip 20 is L2 (mm) (see FIG. 4A), and that the number of steps necessary for conveying stamping plate holder 16 by a distance of L2 is represented by S2, (The relationship between S2 and L2 is expressed by an equation, S2=128×L2. Therefore, the controller starts measuring the number of steps in a pulse signal that is supplied to stepper motor 12, drives stepper motor 12, and conveys stamping plate holder 16 until S2 is reached (S2 step).

Next, after the controller drives stepper motor 12 until the number of steps reaches S2, the controller initializes the variable N for storing the number of printing lines by 1 (Step S19). Next, the controller transfers data relating to Nth line of seal impression and applies heat to thermal head 4 (Step S20).

The length of the conveyance direction of paper strip 20 shall be L3 (mm) (see FIG. 4A) and the number of steps when printing of paper strip 20 finishes shall be S3. The printing of paper strip 20 finishes when variable N for storing the number of printing lines reaches N=S3/16=8×L3.

Therefore, by determines whether N is this value, the controller determines that the printing of stamping plate 20 is finished (Step S21). If variable N for storing the number of printing lines does not satisfy 8×L3 (Step S21: No), the controller adds one to variable N for storing the number of printing lines (Step S22). Next, the controller transfers the data of Nth line again and applies heat to the thermal head 4 (Step S20).

Conversely, if variable N for storing the number of printing lines is 8×L3 (Step S21: Yes), then the controller drives stepper motor 12 only for the number of steps sufficient to eject stamping plate holder 16 (Step S23).

After detecting ejection of stamping plate holder 16 by sensor 3, the controller stops sensor 3 and also stops the driving of stepper motor 12 (Step S24), and finishes plate-making processing.

In this way, in the present disclosure, the area, in which stamping plate 18 is not retained on the printing side of stamping plate holder 16, can be used to display information relating to the stamping face such as the seal impression data and the plate-making date. Also, paper strip 20 which can be printed onto by thermal head 4 is arranged in this area. In this way, information desired by a user can be printed on paper strip 20 during a one-time conveyance step necessary for making stamping plate 18. Therefore, the management of stamping plate 18 becomes greatly simplified.

It should be understood that the present disclosure should not be limited to the above-described embodiment and that many variations and alternative uses are possible.

For example, stamping plate 18 shown in FIG. 4 is a square with four equal sides and stamping plate holder 16 is described as a rectangle; however, the shapes are not limited thereto. A stamping plate holder can be of any shape or dimensions as long as the stamping plate holder is insertable into printer 1, for example, stamping plate 18 can be a rectangle and stamping plate holder 16 can be a square with four equal sides.

Also, in the embodiment presented above, the edge of notch 22 and the edge of stamping plate 18 are explained with the understanding that they are arranged at the same distance from stamping plate holder edge 16a, but they are not limiting. For example, the edge of notch 22 and the edge of stamping plate 18 can deviate from each other. Concretely, the edge of notch 22 deviates so as to be detected first by sensor 3. In other words, the edge of stamping plate 18 is deviating behind the edge of notch 22. Also, the number of steps to corresponds with the deviation (mm) is calculated in advance. As such, it is possible to control the timing the printing by thermal head 4 commences. The decision of the printing start position for plate-making processing in FIG. 9 is conducted as follows. First, sensor 3 detects the edge of notch 22. Then, the controller counts the total number of steps by adding the number of steps corresponding with the deviation to the number of steps calculated in advance based on a distance between sensor 3 and thermal head 4. Then the printing start position is determined.

Also, the materials of stamping plate 18 were introduced as being EVA but are not limited to this. The physical properties can have thermoplasticity and can contain porous materials that enable ink impregnation.

Furthermore, in the above-mentioned embodiment, it was explained that the board-type thick cardboard 21 consists of paper, but as long as it has a desired level of heat-resistance, then materials other than paper can be used.

Also, perforations 25 can be arranged either on top thick cardboard or on bottom thick cardboard in accordance with the purpose of use of stamping plate holder 16 and the extraction method of stamping plate 18. For example, when stamping plate holder 16 is used as a stand to retain a press seal, perforations can be arranged on top thick cardboard 21a to easily bend top thick cardboard 21a into a mountain-shape.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A stamping plate holder comprising:
a board configured to receive a stamping plate on a surface of the board, the stamping plate that comprises a surface configured for plate-making processing to form a stamping face; and
a print medium arranged in an area on the surface of the board, the area being outside of an area that receives the stamping plate.

2. The stamping plate holder according to claim 1, wherein information relating to the stamping face is printed onto the print medium.

3. The stamping plate holder according to claim 2, wherein an adhesive is arranged between the print medium and the board.

4. The stamping plate holder according to claim 3, wherein the print medium is configured to have the adhesive that enables the print medium to be peeled away from the board and re-adhered after peeling away.

5. The stamping plate holder according to claim 4, wherein a conveyance direction in which the board is conveyed while the plate-making processing is performed is predetermined and;
the print medium is arranged at a position on which the plate-making processing is performed before the stamping plate.

6. The stamping plate holder according to claim 5, wherein the stamping plate comprises a porous sponge body that is ink impregnable, and the sponge body is an ethylene-vinyl acetate copolymer.

7. The stamping plate holder according to claim 1, wherein between the print medium and the board an adhesive is arranged.

8. The stamping plate holder according to claim 7, wherein the print medium is configured to have the adhesive that enables the print medium to be peeled away from the board and re-adhered after peeling away.

9. The stamping plate holder according to claim 1, wherein a conveyance direction in which the board is conveyed while the plate-making processing is performed is predetermined; and
the print medium is arranged at a position on which the plate-making processing is performed before the stamping plate.

10. The stamping plate holder according to claim 1, wherein the stamping plate comprises a porous sponge body that is ink impregnable, and the sponge body is an ethylene-vinyl acetate copolymer.
